(19) United States
(12) Patent Application Publication
(10) Pub. No.: US 2024/0190393 A1
(43) Pub. Date: Jun. 13, 2024

(54) MAGNETIZED SNOW REMOVAL BRUSH DEVICE

(71) Applicant: Lucinda Ghiday, Denver, CO (US)

(72) Inventor: Lucinda Ghiday, Denver, CO (US)

(21) Appl. No.: 18/077,324

(22) Filed: Dec. 8, 2022

(51) Int. Cl. B60S 3/04; A46B 15/00

(52) U.S. Cl. CPC B60S 3/045; A46B 15/0081; A46B 2200/3046

(57) ABSTRACT

A magnetized snow removal brush device for removably attaching to an exterior of a vehicle includes an ice scraper facilitating removal of ice from a window of a vehicle. The ice scraper has a top side, a bottom side, a scraper edge, and a pair of side edges. A brush is coupled to the bottom side of the ice scraper and a base is coupled to the side edges of the ice scraper. A tube encloses an interior space and is coupled to the base. A handle is coupled to the tube. A closing fastener and an opening fastener are positioned within the interior space of the tube and releasably fasten the handle in a closing position and an open position respectively. A magnet is coupled to the handle and secures the handle to the exterior of the vehicle assuming the exterior is metallic or is engaged by a magnet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to snow removal brushes and more particularly pertains to a new snow removal brush for removably attaching to an exterior of a vehicle.

### (2) Description of Related Art Including Information Disclosed Under 37 CFR 1.97 and 1.98

The prior art relates to snow removal brushes and includes a variety of snow removal brushes having a brush and a scraper and being configured for removing snow and ice from windows of a vehicle. Known prior art lacks a snow removal brush being removably attached to an exterior of the vehicle.

### BRIEF SUMMARY OF THE INVENTION

An embodiment of the disclosure meets the needs presented above by generally comprising an ice scraper is configured for facilitating removal of ice from a window of a vehicle. The ice scraper has a top side, a bottom side, a scraper edge, and a pair of side edges. The scraper edge is configured for moving in abutment to the window wherein the scraper edge removes the ice. A brush is coupled to the bottom side of the ice scraper and facilitates sweeping snow off from the exterior of the vehicle. A base is coupled to the side edges of the ice scraper. A tube encloses an interior space and is coupled to the base. A handle is coupled to the tube. A closing fastener is positioned within the interior space of the tube and releasably fastens the handle in a closing position. An opening fastener is positioned within the interior space of the tube and releasably fastens the handle in an open position. A spring is coupled to the handle and to the tube and biases the handle from the closed position to the open position. A magnet is coupled to the handle and is configured for removably securing the handle to the exterior of the vehicle assuming the exterior is metallic or can be engaged by a magnet. A strap is coupled to the handle and comprises a closed loop.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a magnetized snow removal brush device according to an embodiment of the disclosure.

FIG. 2 is a side view of an embodiment of the disclosure.

FIG. 3 is a open front view of an embodiment of the disclosure.

FIG. 4 is a cross-sectional view of an embodiment of the disclosure taken along Line 4-4 of FIG. 3.

FIG. 5 is a closed front view of an embodiment of the disclosure.

FIG. 6 is a cross-sectional view of an embodiment of the disclosure taken along Line 6-6 of FIG. 5.

FIG. 7 is a back view of an embodiment of the disclosure.

FIG. 8 is an in-use view of an embodiment of the disclosure.

FIG. 9 is an in-use view of an embodiment of the disclosure.

### DETAILED DESCRIPTION OF THE INVENTION

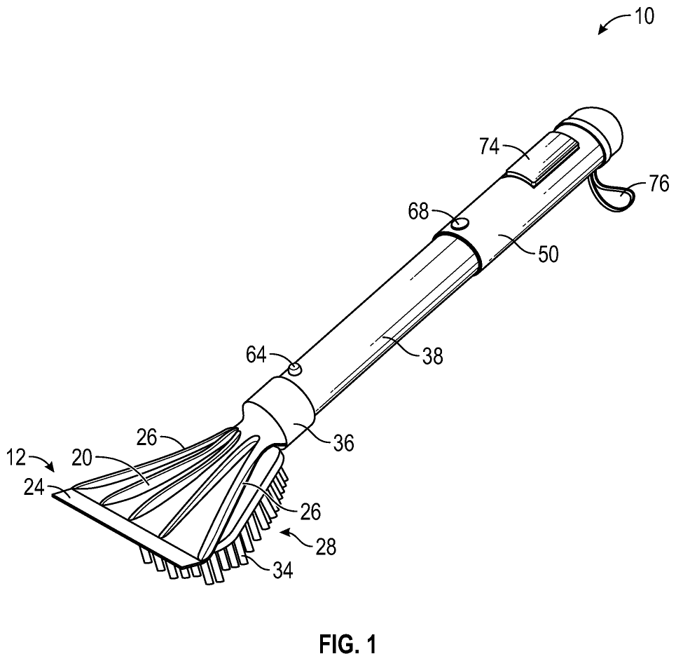

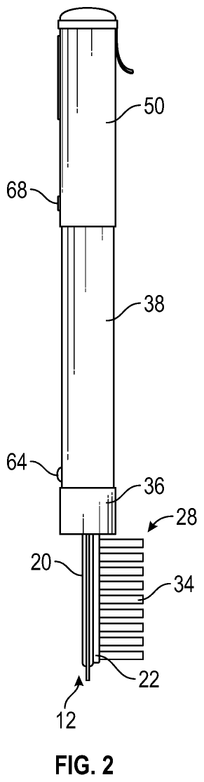

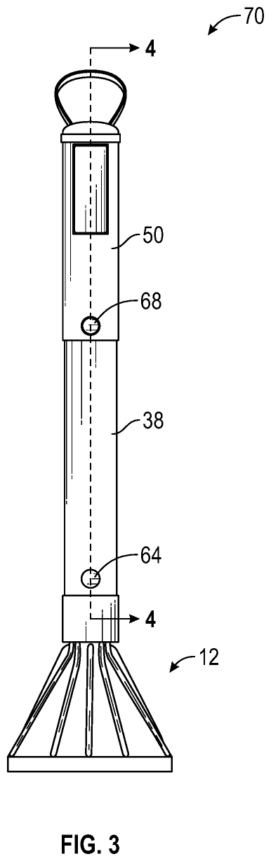

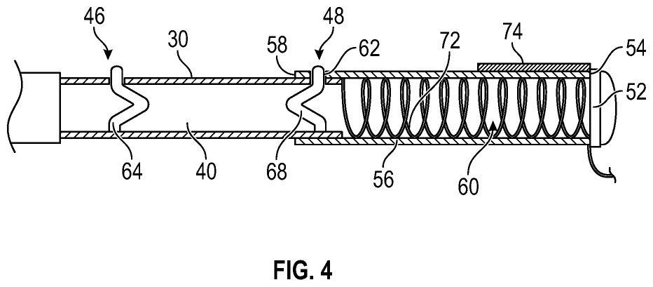

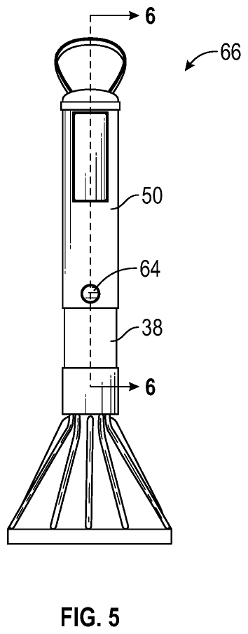

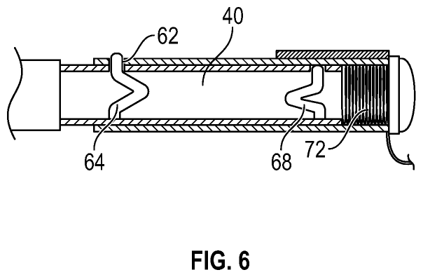

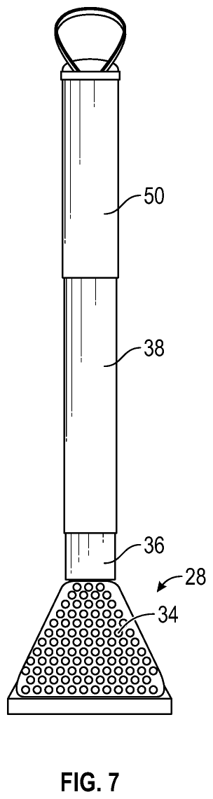

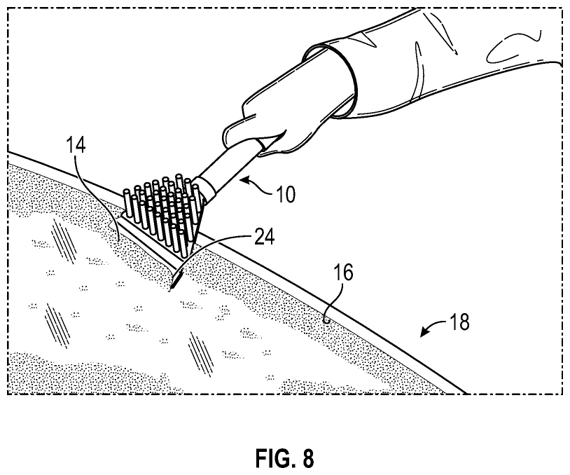

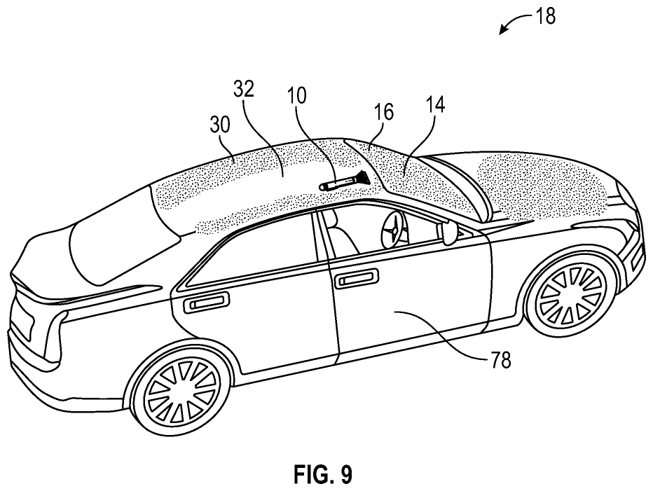

With reference now to the drawings, and in particular to FIGS. 1 through 9 thereof, a new snow removal brush embodying the principles and concepts of an embodiment of the disclosure and generally designated by the reference numeral 10 will be described.

As best illustrated in FIGS. 1 through 9, the magnetized snow removal brush device 10 generally comprises an ice scraper 12 configured for facilitating removal of ice 14 from a window 16 of a vehicle 18. The ice scraper 12 has a top side 20, a bottom side 22, a scraper edge 24, and a pair of side edges 26. The scraper edge 24 is configured for moving in abutment to the window 16 wherein the scraper edge 24 removes the ice 14. A brush 28 is coupled to the bottom side 22 of the ice scraper 12 and facilitates sweeping snow 30 off from the exterior 32 of the vehicle 18. The brush 28 includes a plurality of bristles 34 and each bristle 34 typically has a circular cross-sectional shape.

A base 36 is coupled to the side edges 26 of the ice scraper 12 and has a cylindrical shape. A tube 38 encloses an interior space 40 and is coupled to the base 36. The tube 38 has a distal end 42 and a proximal end 44 relative to the base 36, wherein the proximal end 44 is attached to the base 36. A first hole 46 is positioned proximate to the proximal end 44 and extends through the tube 38. A second hole 48 is positioned proximate to the distal end 42 and extends through the tube 38.

A handle 50 is coupled to the tube 38. The handle 50 includes an end wall 52 having a perimeter edge 54 and a perimeter wall 56 is coupled to the perimeter edge 54 and extends out from the end wall 52. The perimeter wall 56 has an end edge defining an opening 58 to a receiving space 60 of the handle 50. The distal end 42 of the tube 38 is inserted through the opening 58 into the receiving space 60 and an aperture 62 is positioned proximate to the opening 58 and extends through the handle 50.

A closing fastener 64 is positioned within the interior space 40 of the tube 38 and releasably fastens the handle 50 in a closing position 66. The closing fastener 64 typically comprises a button spring clip including a button being inserted within the first hole 46 of the tube 38. The button is removably inserted within the aperture 62 of the handle 50, wherein the closing fastener 64 releasably secures the handle 50 in the closing position 66.

An opening fastener 68 is positioned within the interior space 40 of the tube 38 and releasably fastens the handle 50 in an opening position 70. The opening fastener 68 comprises a button spring clip including a button being inserted within the second hole 48 of the tube 38. The button is removably inserted within the aperture 62 of the handle 50, wherein the opening fastener 68 releasably secures the handle 50 in the opening position 70.

A spring 72 is coupled to the handle 50 and to the tube 38 and biases the handle 50 from the closing position 66 to the opening position 70. The spring 72 is positioned within the receiving space 60 of the handle 50 from the end wall 52 to the distal end 42 of the tube 38, wherein the spring 72 pushes the tube 38 away from the end wall 52. A magnet 74 is coupled to the handle 50 and is configured for removably securing the handle 50 to the exterior 32 of the vehicle 18 assuming the exterior 32 is metallic or can be engaged by the magnet 74. A strap 76 is coupled to the handle 50 and comprises a closed loop. The strap 76 is typically used to removably hang the device 10 from a hanger.

In use, the snow removal brush device 10 is magnetically secured to the exterior 32 of the vehicle 18. When ice 14 and snow 30 accumulate upon the vehicle 18, the user can use the ice scraper 12 and the brush 28 to remove ice 14 and snow 30 from the vehicle 18 prior to opening a door 78 to the vehicle 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A snow and ice removal device being configured for removably securing to an exterior of a vehicle, said snow and ice removal device comprising:
an ice scraper being configured for facilitating removal of ice from a window of a vehicle, said ice scraper having a top side, a bottom side, a scraper edge, and a pair of side edges, said scraper edge being configured for moving in abutment to the window wherein said scraper edge removes the ice;
a brush being coupled to said bottom side of said ice scraper and facilitating sweeping snow off from the exterior of the vehicle;
a base being coupled to said side edges of said ice scraper;
a tube enclosing an interior space and being coupled to said base;
a handle being coupled to said tube;
a closing fastener being positioned within said interior space of said tube and releasably fastening said handle in an closing position;
a opening fastener being positioned within said interior space of said tube and releasably fastening said handle in an open position;
a spring being coupled to said handle and said tube and biasing said handle from said closed position to said open position;
a magnet being coupled to said handle and being configured for removably securing said handle to said exterior of said vehicle assuming the exterior is metallic or can be engaged by a magnet; and
a strap being coupled to said handle and comprising a closed loop.

2. The snow and ice removal device of claim 1, wherein said brush includes a plurality of bristles, each bristle having a circular cross-sectional shape.

3. The snow and ice removal device of claim 1, wherein said base has a cylindrical shape.

4. The snow and ice removal device of claim 1, wherein said tube has a distal end and a proximal end relative to said base, wherein said proximal end is attached to said base, a first hole is positioned proximate to said proximal end and extending through said tube, a second hole is positioned proximate to said distal end and extending through said tube.

5. The snow and ice removal device of claim 1, wherein said handle includes an end wall having a perimeter edge, a perimeter wall being coupled to said perimeter edge and extending out from said end wall, said perimeter wall having an end edge defining an opening to a receiving space of said handle, said distal end of said tube being inserted through said opening into said receiving space, an aperture being positioned proximate to said opening and extending through said handle.

6. The snow and ice removal device of claim 1, wherein said closing fastener comprises a button spring clip including a button being inserted within said first hole of said tube, said button being removably inserted within said aperture of said handle, wherein said closing fastener releasably secures said handle in said closing position.

7. The snow and ice removal device of claim 1, wherein said opening fastener comprises a button spring clip including a button being inserted within said second hole of said tube, said button being removably inserted within said aperture of said handle, wherein said opening fastener releasably secures said handle in said opening position.

8. The snow and ice removal device of claim 1, wherein said spring is positioned within said receiving space of said handle from said end wall to said distal end of said tube, wherein said spring pushes said tube away from said end wall.

9. A snow and ice removal device being configured for removably securing to an exterior of a vehicle, said snow and ice removal device comprising:
an ice scraper being configured for facilitating removal of ice from a window of a vehicle, said ice scraper having a top side, a bottom side, a scraper edge, and a pair of side edges, said scraper edge being configured for moving in abutment to the window wherein said scraper edge removes the ice;
a brush being coupled to said bottom side of said ice scraper and facilitating sweeping snow off from the exterior of the vehicle, said brush including a plurality of bristles, each bristle having a circular cross-sectional shape;
a base being coupled to said side edges of said ice scraper, said base having a cylindrical shape;
a tube enclosing an interior space and being coupled to said base, said tube having a distal end and a proximal end relative to said base, wherein said proximal end is attached to said base, a first hole is positioned proximate to said proximal end and extending through said tube, a second hole is positioned proximate to said distal end and extending through said tube;
a handle being coupled to said tube, said handle including an end wall having a perimeter edge, a perimeter wall being coupled to said perimeter edge and extending out from said end wall, said perimeter wall having an end edge defining an opening to a receiving space of said handle, said distal end of said tube being inserted through said opening into said receiving space, an aperture being positioned proximate to said opening and extending through said handle;
a closing fastener being positioned within said interior space of said tube and releasably fastening said handle in a closing position, said closing fastener comprising a button spring clip including a button being inserted within said first hole of said tube, said button being removably inserted within said aperture of said handle, wherein said closing fastener releasably secures said handle in said closing position;
a opening fastener being positioned within said interior space of said tube and releasably fastening said handle in an open position, said opening fastener comprising a button spring clip including a button being inserted within said second hole of said tube, said button being removably inserted within said aperture of said handle, wherein said opening fastener releasably secures said handle in said opening position;
a spring being coupled to said handle and said tube and biasing said handle from said closing position to said opening position, said spring being positioned within said receiving space of said handle from said end wall to said distal end of said tube, wherein said spring pushes said tube away from said end wall;
a magnet being coupled to said handle and being configured for removably securing said handle to said exterior of said vehicle assuming the exterior is metallic or can be engaged by a magnet; and
a strap being coupled to said handle and comprising a closed loop.
